(19) United States
(12) Patent Application Publication
(10) Pub. No.: US 2025/0272081 A1
(43) Pub. Date: Aug. 28, 2025

(54) TECHNIQUES FOR MANAGING FIRMWARE OVER-THE-AIR FLASHING FOR MULTI-CARE VEHICLE ELECTRONIC CONTROL UNITS

(71) Applicant: FCA US LLC, Auburn Hills, MI (US)

(72) Inventors: Abhilash Gudapati, Troy, MI (US); Varun Khemchandani, Royal Oak, MI (US); Sai Sarath Devarampati, Auburn Hills, MI (US)

(21) Appl. No.: 18/589,609

(22) Filed: Feb. 28, 2024

(51) Int. Cl. G06F 8/654

(52) U.S. Cl. CPC G06F 8/654

(57) ABSTRACT

A firmware over-the-air (FOTA) flash update control technique for a multi-core processor of vehicle involves initially performing, by a first processor core, a FOTA flash update during which a second processor core is configured to temporarily disable a stay awake request to the first processor core via a hardwired wakeup line to allow the first processor core to reset, performing, by the second processor core, the FOTA flash update after the first processor core has successfully performed the FOTA flash update, during which the first processor core is configured to temporarily disable a wakeup request to the second processor core via the hardwired wakeup line, and wherein the first and second processor cores are configured to perform a firmware rollback in the event of a failed or incomplete FOTA flash update by one of the first or second processor cores or another related module on a controller area network (CAN).

### FIELD

The present application generally relates to vehicle firmware over-the-air (FOTA) flash updates and, more particularly, to techniques for managing FOTA flashing for multi-core vehicle electronic control units (ECUs).

### BACKGROUND

Today's vehicles often include a plurality of different electronic control units (ECUs) and the capability to perform firmware over-the-air (FOTA) flash updates. FOTA flash updates are performed automatically by the vehicle in response to an FOTA broadcast and thus differ from conventional manual/supervised flash updates by a vehicle service technician via a physical diagnostic tool. In the event of a failed or incomplete FOTA flash update of one of a plurality of ECUs or modules, a rollback is performed where all of the ECUs or modules revert to their previous (pre-flash) firmware. In some vehicles, a particular ECU could have multiple processors or multiple processor cores to increase redundancy, e.g., for improved functional safety. FOTA flash updates and rollbacks become increasingly difficult when there are multiple processors or processor cores arranged in a primary/secondary configuration. Accordingly, while such conventional FOTA flash update techniques do work for their intended purpose, there exists an opportunity for improvement in the relevant art.

### SUMMARY

According to one example aspect of the invention, a firmware over-the-air (FOTA) flash update control system for a vehicle is presented. In one exemplary implementation, the FOTA flash update control system comprises a FOTA supervisor module configured to control receipt of an FOTA flash update via a wireless communication medium and a power inverter module (PIM) connected to the FOTA supervisor module via a controller area network (CAN) and configured to receive the FOTA flash update and an FOTA flash update status, wherein the PIM comprises a hybrid control processor (HCP) and an auxiliary HCP (AHCP), wherein the HCP is configured to wakeup the AHCP via a hardwired wakeup line and the AHCP is configured to provide a stay awake request to the HCP via the hardwire wakeup line, wherein the HCP is configured to perform the FOTA flash update before the AHCP, during which the AHCP is configured to temporarily disable the stay awake request to the HCP via the hardwired wakeup line to allow the HCP to reset, and wherein the AHCP is configured to perform the FOTA flash update after the HCP has successfully performed the FOTA flash update, during which the HCP is configured to temporarily disable a wakeup request to the AHCP via the hardwired wakeup line, and wherein the HCP and the AHCP are configured to perform a firmware rollback in the event of a failed or incomplete FOTA flash update by one of the HCP, the AHCP, or another related module on the CAN.

In some implementations, the HCP and the AHCP are separate cores of a multi-core processor of the PIM. In some implementations, the HCP is configured to perform the firmware rollback before the AHCP performs the firmware rollback. In some implementations, the FOTA supervisor module generates a rollback command when the FOTA flash update by the AHCP fails, the HCP responds to the rollback command from the FOTA supervisor module and performs the firmware rollback, and the AHCP receives the rollback command from the FOTA supervisor module while being kept awake by the HCP and performs the firmware rollback after the HCP. In some implementations, the AHCP is configured to perform the firmware rollback before the HCP performs the firmware rollback. In some implementations, the FOTA supervisor module generates a rollback command when the FOTA flash update by the AHCP fails, the AHCP responds to the rollback command from the FOTA supervisor module and performs the firmware rollback, and the HCP receives the rollback command from the FOTA supervisor module while the AHCP temporarily disables the stay awake request to the HCP via the hardwired wakeup line and performs the firmware rollback after the AHCP.

In some implementations, the FOTA supervisor module generates a rollback command when the FOTA flash update by the HCP fails, the AHCP receives the rollback command from the FOTA supervisor module and does not perform the FOTA flash update, and the HCP receives the rollback command from the FOTA supervisor module while the AHCP temporarily disables the stay awake request to the HCP via the hardwired wakeup line and performs the firmware rollback. In some implementations, the FOTA supervisor module generates a rollback command when the FOTA flash update by the other related module on the CAN fails, the AHCP responds to the rollback command from the FOTA supervisor module and performs the firmware rollback, and the HCP receives the rollback command from the FOTA supervisor module while the AHCP temporarily disables the stay awake request to the HCP via the hardwired wakeup line and performs the firmware rollback after the AHCP.

According to another example aspect of the invention, a FOTA flash update control method for a vehicle is presented. In one exemplary implementation, the FOTA flash update control method comprises providing a FOTA supervisor module configured to control receipt of an FOTA flash update via a wireless communication medium, providing a PIM connected to the FOTA supervisor module via a CAN and configured to receive the FOTA flash update and an FOTA flash update status, wherein the PIM comprises an HCP and an AHCP, wherein the HCP is configured to wakeup the AHCP via a hardwired wakeup line, performing, by the HCP, the FOTA flash update before the AHCP, during which the AHCP is configured to temporarily disable a stay awake request to the HCP via the hardwired wakeup line to allow the HCP to reset, performing, by the AHCP, the FOTA flash update after the HCP has successfully performed the FOTA flash update, during which the HCP is configured to temporarily disable a wakeup request to the AHCP via the hardwired wakeup line, and wherein the HCP and the AHCP are configured to perform a firmware rollback in the event of a failed or incomplete FOTA flash update by one of the HCP, the AHCP, or another related module on the CAN.

In some implementations, the HCP and the AHCP are separate cores of a multi-core processor of the PIM. In some implementations, the HCP is configured to perform the firmware rollback before the AHCP performs the firmware rollback. In some implementations, the FOTA supervisor module generates a rollback command when the FOTA flash update by the AHCP fails, the HCP responds to the rollback command from the FOTA supervisor module and performs the firmware rollback, and the AHCP receives the rollback command from the FOTA supervisor module while being kept awake by the HCP and performs the firmware rollback after the HCP. In some implementations, the AHCP is configured to perform the firmware rollback before the HCP performs the firmware rollback. In some implementations, the FOTA supervisor module generates a rollback command when the FOTA flash update by the AHCP fails, the AHCP responds to the rollback command from the FOTA supervisor module and performs the firmware rollback, and the HCP receives the rollback command from the FOTA supervisor module while the AHCP temporarily disables the wakeup request to the HCP via the hardwired wakeup line and performs the firmware rollback after the AHCP.

In some implementations, the FOTA supervisor module generates a rollback command when the FOTA flash update by the HCP fails, the AHCP receives the rollback command from the FOTA supervisor module and does not perform the FOTA flash update, and the HCP receives the rollback command from the FOTA supervisor module while the AHCP temporarily disables the stay awake request to the HCP via the hardwired wakeup line and performs the firmware rollback. In some implementations, the FOTA supervisor module generates a rollback command when the FOTA flash update by the other related module on the CAN fails, the AHCP responds to the rollback command from the FOTA supervisor module and performs the firmware rollback, and the HCP receives the rollback command from the FOTA supervisor module while the AHCP temporarily disables the stay awake request to the HCP via the hardwired wakeup line and performs the firmware rollback after the AHCP.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIGS. 1A-1B are functional block diagrams of a vehicle and an example firmware over-the-air (FOTA) flash update control system according to the principles of the present application; and

FIGS. 2A-2B are flow diagrams of first and second example FOTA flash update control methods for a vehicle according to the principles of the present application.

### DESCRIPTION

As previously discussed, firmware over-the-air (FOTA) flash updates are performed automatically by a vehicle in response to an FOTA broadcast and thus differ from conventional manual/supervised flash updates by a vehicle service technician via a physical diagnostic tool. In the event of a failed or incomplete FOTA flash update of one of a plurality of electronic control units (ECUs) or modules, a rollback is performed where all of the ECUs or modules revert to their previous (pre-flash) firmware. In some vehicles, a particular ECU could have multiple processors or multiple processor cores to increase redundancy, e.g., for improved functional safety. FOTA flash updates and rollbacks become increasingly difficult when there are multiple processors or processor cores arranged in a primary/secondary configuration. Accordingly, improved vehicle FOTA flash update control systems and methods are presented herein that requires the secondary processor to become a smart secondary module rather than a traditional follower. Two distinct solutions or sequences are also proposed herein. In a first sequence or solution, the primary processor flashes before the secondary processor and also performs rollback, if necessary, before the secondary processor. In a second sequence or solution, the primary processor flashes before the secondary processor, but the secondary processor performs rollback, if necessary, before the primary processor.

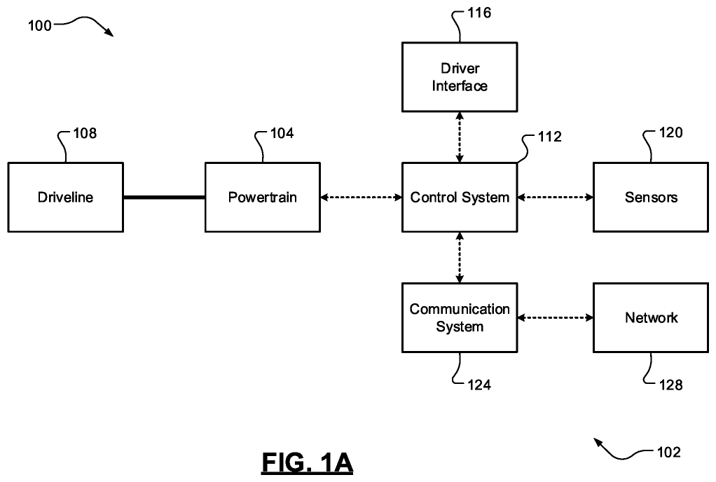

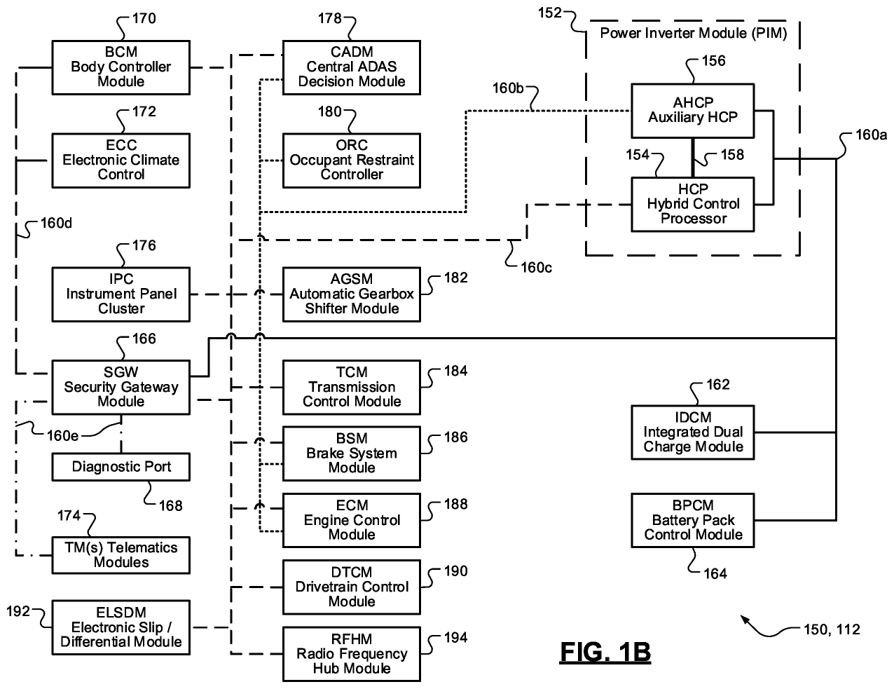

Referring now to FIGS. 1A-1B, functional block diagrams of a vehicle 100 and an example FOTA flash update control system 102 according to the principles of the present application are illustrated. The vehicle 100 generally comprises a powertrain 104 configured to generate and transfer drive torque to a driveline 108 for vehicle propulsion. The powertrain 104 is an electrified powertrain that includes at least two electric motors and an optional internal combustion engine arranged in any suitable configuration (e.g., a series-parallel hybrid configuration with one electric motor and the optional engine arranged at one axle and the other electric motor arranged at another axle). A controller or control system 112 controls operation of the vehicle 100, including primarily controlling the powertrain 104 to generate and transfer a desired amount of drive torque to the driveline 108 to satisfy a driver torque request via a driver interface 116, such as an accelerator pedal. The control system 112 controls the powertrain 104 and other systems as described in greater detail below based on measurements from a plurality of sensors 120. The vehicle 100 also includes a communication system 124 (e.g., one or more transceivers) configured to receive FOTA flash update requests/data via a network 128, such as a long-range wireless communication network (e.g., a cellular data network).

FIG. 1B illustrates a specific configuration 150 of the control system 112. A power inverter module (PIM) 152 is a supervisory controller for vehicle propulsion (i.e., the powertrain 104) such as, for example, first and second electric motors (e.g., Motors A and B) of the powertrain 104. The PIM 152 includes a hybrid control processor (HCP) 154 and a separate auxiliary HCP (AHCP) 156 that are configured to perform at least some redundant functions for improved functional safety. The HCP 154 and the AHCP 156 could be, for example, multiple cores of a same processor or processing unit of the PIM 152, but it will also be appreciated that the HCP 154 and the AHCP 156 could be separate processors or processing units arranged in a specific redundant primary/secondary configuration. The HCP 154 is a wakeable via a CAN 160 (CAN bus 160a) and the AHCP is only wakeable via a hardwired wakeup line 158. Other modules on bus 160a (also referred to as an electrified powertrain or “ePT” bus) include an integrated dual charge module (IDCM) 162, a battery pack control module (BPCM) 164, and a security gateway (SGW) module 166. The SGW module 166 is connected to a traditional diagnostic interface port 168 and a FOTA supervisor controller or module is the SGW module 166 in this configuration. Thus, for the remainder of this description, the SGW module 166 can also be referred to as the “FOTA supervisor 166” or the “FOTA supervisor module 166.”

The remaining components of the control system 112 are illustrated and generally include: a body controller module (BCM) 170 and an electronic climate control (ECC) 172 on a CAN bus 160d with the SGW module 166, one or more telematics modules (TMs) 174 on a CAN bus 160e with the SGW module 166, an instrument panel cluster (IPC) 176, a central advanced driver-assistance system (ADAS) decision module (CADM) 178, an automatic gearbox shifter module (AGSM) 182, a transmission control module (TCM) 184, a brake system module (BSM) 186, an engine control module (ECM) 188, a drivetrain control module (DTCM) 190, an electronic slip/differential module (ELSDM) 192, and a radio frequency hub module (RFHM) 194 on a CAN bus 160c with the SGW module 166, the BCM 170, and the HCP 154, and an occupant restraint controller (ORC) 180 on a CAN bus 160b with the CADM module 178, the BSM 186, the ECM 188, and the AHCP 156. It will be appreciated that there can also be other modules/components that are not illustrated, such as other local interconnect networks (LINs) and the like.

In conventional FOTA flash techniques, problems arise when a flash failure occurs due to the secondary processor or ECU flashing first and the primary processor or ECU flashing second in a flashing sequence because the primary processor or ECU must keep the secondary processor or ECU wakeup active before the secondary processor ECU goes into a boot mode to complete the flash update. The HCP 154 and the AHCP 156 of the present application always need to be flashed together due to the above-described functional dependency. The HCP 154 and the AHCP 156 being primary and secondary microcontrollers, respectively, brings in more complexity to the flash update process as they are treated as separate ECUs by the FOTA supervisor 166. To meet all FOTA flash rules that need to be followed by each ECU, the innovation described herein is necessary for multi-core ECUs such as the HCP 154 and the AHCP 156. In the case of a flash update failure and firmware rollback, the AHCP 156 first and HCP 154 second might not be technically feasible due to how the interfaces between both microcontrollers are designed and thus will not meet the FOTA functional requirements. In a conventional non-FOTA flash event (e.g., handled by an operator through flash tools), there is no firmware rollback sequence. That is, if the AHCP 156 flash is successful and the HCP 154 flash fails, the operator will attempt to retrieve the HCP 154 by re-flashing and, if the execution fails, the whole PIM 152 (the HCP 154 and the AHCP 156) is replaced. Due to the lack of manual intervention/retrieval under the FOTA flash update process, the flashing sequence of the secondary module first and primary module second will lead to an imminent failure of the whole PIM 152 causing replacement and thereby stranding the customer/driver after an FOTA flash.

The problems with the above scenario—the AHCP 156 followed by the HCP 154 in flashing, and the AHCP 156 followed by the HCP 154 in rollback—will now be described in more detail. First, the HCP 154 is woken up through wakeup input to enter a diagnostic session. The HCP 154 then wakes up the AHCP 156 through the hardwired wakeup line 158. The AHCP 156 is flashed first by the FOTA supervisor module 168. If the flash of the AHCP 156 fails, because the HCP 154 is still awake, the hardwired wakeup line 158 is pulled high. The rollback on the AHCP 156 would therefore still be possible. If the AHCP 156 has a successful flash, the HCP 154 will be flashed next. The AHCP 156 will not let the HCP 154 go into power down due to the AHCP 156 having the capability to request the HCP 154 stay awake due to the network management that occurs on 160a during an active diagnostic session. As the FOTA flash for both the HCP 154 and the AHCP 156 is occurring on CAN bus 160a, all the other modules on bus 160a will also need to participate in an active diagnostic session with the FOTA supervisor 166 to seamlessly complete the FOTA flash.

Network management messages that keep the AHCP 156 awake will make the AHCP 156 believe that the CAN is not ready to go to sleep and thus the AHCP 156 will keep the HCP 154 awake causing the HCP 154 to never enter a boot mode and thus causing the FOTA flash to fail and thus requiring the AHCP 156 to rollback. Thus, the AHCP 156 is re-flashed (rollback) and, if successful, a reset is required after a flash event to provide a positive response of completing the flash successfully to the FOTA supervisor 166. This reset will be possible as the HCP 154 never went into boot mode and the whole FOTA flash failed. Even if the HCP 154 is forced to enter a boot mode even with AHCP 156 requesting to keep the HCP 154 awake. If the AHCP 156 will be alive on its own during HCP flashing, in a case where HCP 154 will fail its flash, then the AHCP 156 cannot be successfully rolled back as HCP 154 has already failed its flash. This will not be possible, however, as the HCP 154 has already failed its flash and will thus not assert a wakeup. Due to lack of recognition of a wakeup line that it requires to stay awake, the AHCP 156 may be unable to reset itself, causing the HCP 154 and AHCP 156 flash failures, in turn causing the FOTA flash to fail. This could result in the customer/driver not being able to start/drive the vehicle 100 anymore as the HCP 154 is the propulsion supervisory controller (of the PIM 152). Modules which are not secondary and have the capability to be woken up on CAN have the capability to stay awake for a period (e.g., 5 minutes) after a flash session and reset occurs. The AHCP 156, however, being a secondary module, does not fall under this classification and has a dependency of the hardwired wakeup line 158 from the HCP 154.

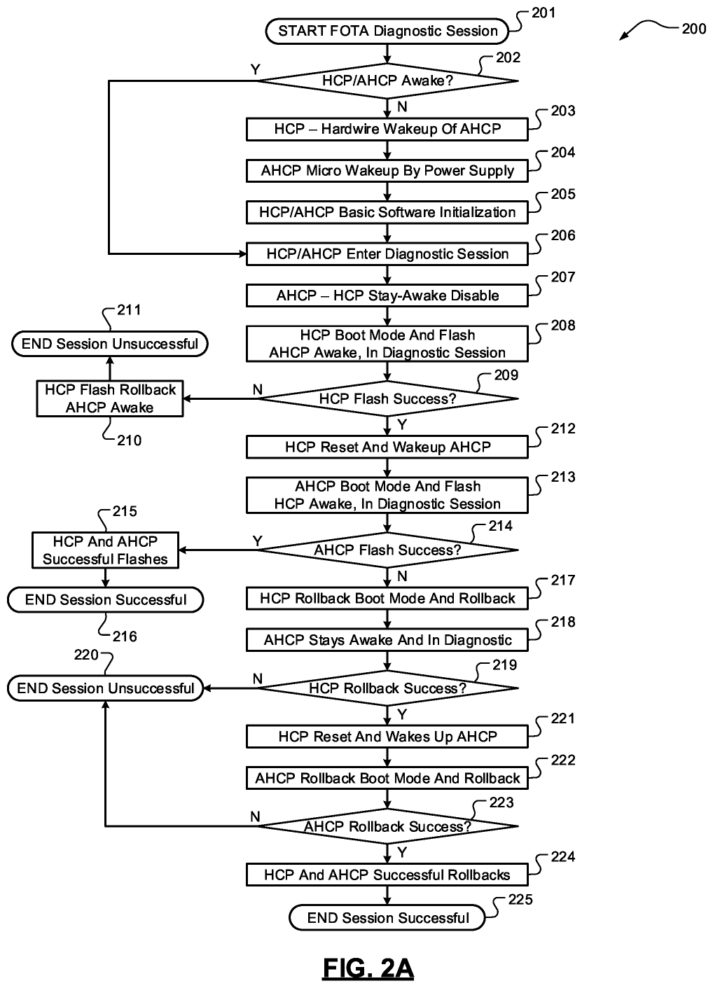

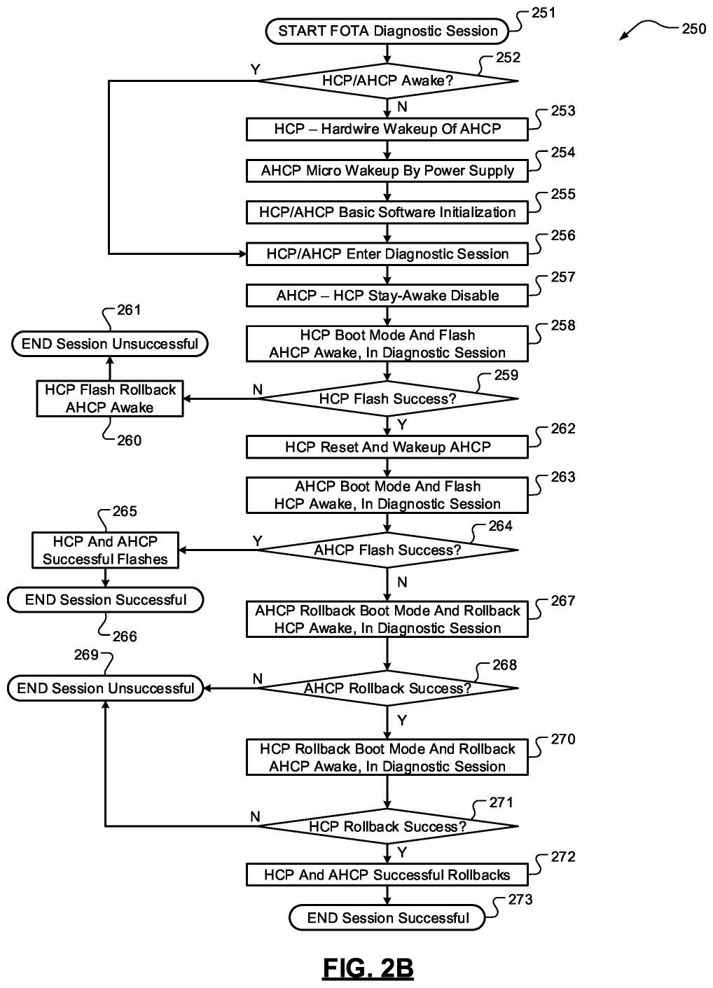

Referring now to FIG. 2A and with continued reference to FIGS. 1A-1B, a flow diagram of a first example FOTA flash update control method 200 for a vehicle according to the principles of the present application is illustrated. While the components of the vehicle 100 and the control system 150 are specifically referenced for illustrative/descriptive purposes, it will be appreciated that the method 200 could be applicable to any suitable configured vehicle having a multi-core processor or ECU. The method 200 begins at 201 where the FOTA supervisor 166 begins the FOTA diagnostic session. At 202, it is determined whether the HCP 154 and the AHCP 156 were already awake. If false, the method 200 proceeds to 203. If true, the method 200 proceeds to 206. At 203, the HCP 154 activates the hardwire wakeup line 158 to the AHCP 156 due to the diagnostic session wakeup. At 204, the AHCP 156 power supply detects the wakeup input and wakes up its microprocessor. At 205, the HCP 154 and the AHCP 156 basic software initializes all input/outputs and zipwire, initializes CAN hardware, and starts receiving CAN messages on applicable CAN buses. At 206, the HCP 154 and the AHCP 156 enter a diagnostic session and response to the commands from the FOTA supervisor 166. At 207, the AHCP 156 disables the HCP 154 stay-awake request due to the diagnostic session recognition. At 208, the HCP 154 enters a boot mode, performs a flash based on the commands from the FOTA supervisor 166, and the AHCP 156 continues to stay awake and participate in the FOTA diagnostic session. At 209, it is determined whether the flash of the HCP 154 was successful. If true, the method 200 proceeds to 212. If false, the method 200 proceeds to 210. At 210, the HCP 154 performs a firmware rollback based on commands from the FOTA supervisor 166 and the AHCP 156 continues to stay awake and participate in the diagnostic session. At 211, the FOTA supervisor 166 determines that the FOTA diagnostic session was unsuccessful and the method 200 ends.

At 212, the HCP 154 resets itself and activates the hardwired wakeup line 158 to the AHCP 156. At 213, the AHCP 156 enters a boot mode and performs a flash based on commands from the FOTA supervisor 166 and the HCP 154 continues to stay awake and participate in the diagnostic session. At 214, it Is determined whether the flash of the AHCP 156 was successful. If false, the method 200 proceeds to 217. If true, the method 200 proceeds to 215. At 215, the FOTA supervisor 166 determines that the HCP 154 and the AHCP 156 both had a successful flash. At 216, the method 200 ends with a successful FOTA diagnostic session. At 217, the HCP 154 enters a rollback boot mode and performs a flash rollback based on commands from the FOTA supervisor 166. At 218, the AHCP 156 can remain awake on its own after its flash failure and continue to participate in the diagnostic session. At 219, it is determined whether the rollback of the HCP 154 was successful. If false, the method 200 proceeds to 220. If true, the method 200 proceeds to 221. At 220, the method 200 ends with an unsuccessful FOTA diagnostic session. At 221, the HCP 154 resets itself and activates the hardwired wakeup line 158 to the AHCP 156. At 222, the AHCP 156 enters a rollback boot mode and performs a flash rollback based on commands from the FOTA supervisor 166 while the HCP 154 continues to stay awake and participate in the diagnostic session. At 223, it is determined whether the rollback of the AHCP 156 was successful. If false, the method 200 proceeds to 220 and ends. If true, the method 200 proceeds to 224. At 224, the FOTA supervisor 166 determines that the HCP 154 and the AHCP 156 both had a successful flash rollback. At 225, the method 200 ends with a successful diagnostic session, but with the HCP 154 and the AHCP 156 having not received the flash update. The method 200, for example, could then attempt another run until the flash update of both the HCP 154 and the AHCP 156 is successful.

Referring now to FIG. 2A and with continued reference to FIGS. 1A-1B, a flow diagram of a first example FOTA flash update control method 250 for a vehicle according to the principles of the present application is illustrated. While the components of the vehicle 100 and the control system 200 are specifically referenced for illustrative/descriptive purposes, it will be appreciated that the method 250 could be applicable to any suitable configured vehicle having a multi-core processor or ECU. The method 250 begins at 251 where the FOTA supervisor 166 begins the FOTA diagnostic session. At 252, it is determined whether the HCP 154 and the AHCP 156 were already awake. If false, the method 250 proceeds to 253. If true, the method 250 proceeds to 256. At 253, the HCP 154 activates the hardwire wakeup line 158 to the AHCP 156 due to the diagnostic session wakeup. At 254, the AHCP 156 power supply detects the wakeup input and wakes up its microprocessor. At 255, the HCP 154 and the AHCP 156 basic software initializes all input/outputs and zipwire, initializes CAN hardware, and starts receiving CAN messages on applicable CAN buses. At 256, the HCP 154 and the AHCP 156 enter a diagnostic session and response to the commands from the FOTA supervisor 166. At 257, the AHCP 156 disables the HCP 154 stay-awake request due to the diagnostic session recognition. At 258, the HCP 154 enters a boot mode, performs a flash based on the commands from the FOTA supervisor 166, and the AHCP 156 continues to stay awake and participate in the FOTA diagnostic session. At 259, it is determined whether the flash of the HCP 154 was successful. If true, the method 250 proceeds to 262. If false, the method 250 proceeds to 260. At 260, the HCP 154 performs a firmware rollback based on commands from the FOTA supervisor 166 and the AHCP 156 continues to stay awake and participate in the diagnostic session. At 261, the FOTA supervisor 166 determines that the FOTA diagnostic session was unsuccessful and the method 250 ends.

At 262, the HCP 154 resets itself and activates the hardwired wakeup line 158 to the AHCP 156. At 263, the AHCP 156 enters a boot mode and performs a flash based on commands from the FOTA supervisor 166 and the HCP 154 continues to stay awake and participate in the diagnostic session. At 264, it Is determined whether the flash of the AHCP 156 was successful. If false, the method 250 proceeds to 267. If true, the method 250 proceeds to 265. At 265, the FOTA supervisor 166 determines that the HCP 154 and the AHCP 156 both had a successful flash. At 266, the method 250 ends with a successful FOTA diagnostic session. At 267, the AHCP 156 enters a rollback boot mode and performs a flash rollback based on commands from the FOTA supervisor 166 and the HCP 154 continues to stay awake and participate in the diagnostic session. At 268, it is determined whether the rollback of the AHCP 156 was successful. If false, the method 250 proceeds to 269. If true, the method 250 proceeds to 270. At 269, the method 250 ends with an unsuccessful FOTA diagnostic session. At 270, the HCP 154 enters a rollback boot mode and performs a flash rollback based on commands from the FOTA supervisor 166 while the AHCP 156 continues to stay awake and participate in the diagnostic session. At 271, it is determined whether the rollback of the HCP 154 was successful. If false, the method 250 proceeds to 269 and ends. If true, the method 250 proceeds to 272. At 272, the FOTA supervisor 166 determines that the HCP 154 and the AHCP 156 both had a successful flash rollback. At 273, the method 250 ends with a successful diagnostic session, but with the HCP 154 and the AHCP 156 having not received the flash update. The method 250, for example, could then attempt another run until the flash update of both the HCP 154 and the AHCP 156 is successful.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A firmware over-the-air (FOTA) flash update control system for a vehicle, the FOTA flash update control system comprising:
a FOTA supervisor module configured to control receipt of an FOTA flash update via a wireless communication medium; and
a power inverter module (PIM) connected to the FOTA supervisor module via a controller area network (CAN) and configured to receive the FOTA flash update and an FOTA flash update status, wherein the PIM comprises:
a hybrid control processor (HCP) and an auxiliary HCP (AHCP), wherein the HCP is configured to wakeup the AHCP via a hardwired wakeup line and the AHCP is configured to provide a stay awake request to the HCP via the hardwire wakeup line,
wherein the HCP is configured to perform the FOTA flash update before the AHCP, during which the AHCP is configured to temporarily disable the stay awake request to the HCP via the hardwired wakeup line to allow the HCP to reset, and wherein the AHCP is configured to perform the FOTA flash update after the HCP has successfully performed the FOTA flash update, during which the HCP is configured to temporarily disable a wakeup request to the AHCP via the hardwired wakeup line, and
wherein the HCP and the AHCP are configured to perform a firmware rollback in the event of a failed or incomplete FOTA flash update by one of the HCP, the AHCP, or another related module on the CAN.

2. The FOTA flash update control system of claim 1, wherein the HCP and the AHCP are separate cores of a multi-core processor of the PIM.

3. The FOTA flash update control system of claim 1, wherein the HCP is configured to perform the firmware rollback before the AHCP performs the firmware rollback.

4. The FOTA flash update control system of claim 3, wherein:
the FOTA supervisor module generates a rollback command when the FOTA flash update by the AHCP fails;
the HCP responds to the rollback command from the FOTA supervisor module and performs the firmware rollback; and
the AHCP receives the rollback command from the FOTA supervisor module while being kept awake by the HCP and performs the firmware rollback after the HCP.

5. The FOTA flash update control system of claim 1, wherein the AHCP is configured to perform the firmware rollback before the HCP performs the firmware rollback.

6. The FOTA flash update control system of claim 5, wherein:
the FOTA supervisor module generates a rollback command when the FOTA flash update by the AHCP fails;
the AHCP responds to the rollback command from the FOTA supervisor module and performs the firmware rollback; and
the HCP receives the rollback command from the FOTA supervisor module while the AHCP temporarily disables the stay awake request to the HCP via the hardwired wakeup line and performs the firmware rollback after the AHCP.

7. The FOTA flash update control system of claim 5, wherein:
the FOTA supervisor module generates a rollback command when the FOTA flash update by the HCP fails;
the AHCP receives the rollback command from the FOTA supervisor module and does not perform the FOTA flash update; and
the HCP receives the rollback command from the FOTA supervisor module while the AHCP temporarily disables the stay awake request to the HCP via the hardwired wakeup line and performs the firmware rollback.

8. The FOTA flash update control system of claim 5, wherein:
the FOTA supervisor module generates a rollback command when the FOTA flash update by the other related module on the CAN fails;
the AHCP responds to the rollback command from the FOTA supervisor module and performs the firmware rollback; and
the HCP receives the rollback command from the FOTA supervisor module while the AHCP temporarily disables the stay awake request to the HCP via the hardwired wakeup line and performs the firmware rollback after the AHCP.

9. A firmware over-the-air (FOTA) flash update control method for a vehicle, the FOTA flash update control method comprising:
providing a FOTA supervisor module configured to control receipt of an FOTA flash update via a wireless communication medium;
providing a power inverter module (PIM) connected to the FOTA supervisor module via a controller area network (CAN) and configured to receive the FOTA flash update and an FOTA flash update status, wherein the PIM comprises a hybrid control processor (HCP) and an auxiliary HCP (AHCP), wherein the HCP is configured to wakeup the AHCP via a hardwired wakeup line,
performing, by the HCP, the FOTA flash update before the AHCP, during which the AHCP is configured to temporarily disable a stay awake request to the HCP via the hardwired wakeup line to allow the HCP to reset;
performing, by the AHCP, the FOTA flash update after the HCP has successfully performed the FOTA flash update, during which the HCP is configured to temporarily disable a wakeup request to the AHCP via the hardwired wakeup line, and
wherein the HCP and the AHCP are configured to perform a firmware rollback in the event of a failed or incomplete FOTA flash update by one of the HCP, the AHCP, or another related module on the CAN.

10. The FOTA flash update control method of claim 9, wherein the HCP and the AHCP are separate cores of a multi-core processor of the PIM.

11. The FOTA flash update control method of claim 9, wherein the HCP is configured to perform the firmware rollback before the AHCP performs the firmware rollback.

12. The FOTA flash update control method of claim 11, wherein:
the FOTA supervisor module generates a rollback command when the FOTA flash update by the AHCP fails;
the HCP responds to the rollback command from the FOTA supervisor module and performs the firmware rollback; and
the AHCP receives the rollback command from the FOTA supervisor module while being kept awake by the HCP and performs the firmware rollback after the HCP.

13. The FOTA flash update control method of claim 9, wherein the AHCP is configured to perform the firmware rollback before the HCP performs the firmware rollback.

14. The FOTA flash update control method of claim 13, wherein:
the FOTA supervisor module generates a rollback command when the FOTA flash update by the AHCP fails;
the AHCP responds to the rollback command from the FOTA supervisor module and performs the firmware rollback; and
the HCP receives the rollback command from the FOTA supervisor module while the AHCP temporarily disables the wakeup request to the HCP via the hardwired wakeup line and performs the firmware rollback after the AHCP.

15. The FOTA flash update control method of claim 13, wherein:
the FOTA supervisor module generates a rollback command when the FOTA flash update by the HCP fails;
the AHCP receives the rollback command from the FOTA supervisor module and does not perform the FOTA flash update; and
the HCP receives the rollback command from the FOTA supervisor module while the AHCP temporarily disables the stay awake request to the HCP via the hardwired wakeup line and performs the firmware rollback.

16. The FOTA flash update control method of claim 13, wherein:
the FOTA supervisor module generates a rollback command when the FOTA flash update by the other related module on the CAN fails;
the AHCP responds to the rollback command from the FOTA supervisor module and performs the firmware rollback; and
the HCP receives the rollback command from the FOTA supervisor module while the AHCP temporarily disables the stay awake request to the HCP via the hardwired wakeup line and performs the firmware rollback after the AHCP.
